(19) United States
(12) Patent Application Publication
(10) Pub. No.: US 2009/0044707 A1
(43) Pub. Date: Feb. 19, 2009

(54) Oil quality sensor and oil heater for deep fryers

(75) Inventors: Jan Claesson, Land O'Lakes, FL (US); Nathan Baker, Land O'Lakes, FL (US); Doug Jones, New Port Richey, FL (US); Martin Behle, Remscheid (DE)

Correspondence Address: Paul D. Greeley;Ohlandt, Greeley, Ruggiero & Perle, L.L.P., 10th Floor, One Landmark Square, Stamford, CT, 06901-2682, US

(73) Assignee: FRYMASTER, L.L.C.

(21) Appl. No.: 12/215,307

(22) Filed: Jun. 26, 2008

Related U.S. Application Data
(60) Provisional application No. 60/937,513, filed on Jun. 28, 2007.
(60) Provisional application No. 60/995,527, filed on Sep. 27, 2007.

(51) Int. Cl. A47J 37/12; G01N 21/00

(52) U.S. Cl. 99/403; 99/330; 356/436

(57) ABSTRACT

An sensor for a monitoring oil in a deep fryer system having at least one fryer pot and a pipe directing oil to the fryer pot has a first sensor and a second sensor, and a first transmitter disposed for transmitting light through the oil to the first sensor and a second transmitter disposed for transmitting light through the oil to the second sensor. The sensor also has a processor for comparing a signal received from the first sensor and a signal received from the second sensor, wherein a notification is provided when a difference between signals exceeds a predetermined threshold.

This application claims the benefit of U.S. Provisional Patent Application Ser. No. 60/937,513, filed on Jun. 28, 2007 and Provisional Patent Application Ser. No. 60/995,527 filed on Sep. 27, 2007, the contents of which are incorporated by reference herein.

### BACKGROUND OF THE INVENTION

1. Field of the Invention

This invention relates to an oil quality sensor that is installed in a deep fryer for the purpose of indicating when the cooking oil should be changed. This invention also relates to oil quality sensor that is disposed inline with a heater for maintaining the cooking oil temperature after draining and after filtration of the cooking oil to maintain oil quality sensor accuracy.

2. Description of Related Art

During use, the oil in a deep fryer is degraded and loses its cooking capacity. Impurities from the deep fried food and cyclic temperature increases during the life of the oil limit the cooking capacity.

Other devices have been used to sense the oil quality; however they have drawbacks. Oil density sensors and oil viscosity sensors are typically placed within the oil stream and are easily clogged with debris. Sensors that sense the magnetism of the particulate matter in the oil can be cost prohibitive.

Accordingly, there is a need for an oil quality sensor for installation at various locations in a deep fryer that uses LEDs and photosensors to indicate the oil quality and allow operators to determine when the cooking oil should be changed. There is also a need for a heater disposed inline with the oil quality sensor to maintain the oil viscosity and oil quality sensor accuracy.

### SUMMARY OF THE INVENTION

The present disclosure provides for an oil quality sensor for a deep fryer pot that uses colored LEDs and photosensors to determine the coloration change in a sample of cooking oil. The coloration change is indicative of a reduction of oil quality.

The present disclosure also provides for an oil quality sensor for a deep fryer that transmits light from colored LEDs through an oil sample of a deep fryer. The transmitted light is received by photosensors and the resultant signals are processed to determine the color change in a sample of oil. The change in color of the oil sample is indicative of oil degradation.

The present disclosure further provides for an oil quality sensor that is installed in a recirculation system of a deep fryer to enable the sensor to be used for several fryer pots simultaneously.

The present disclosure still further provides for oil quality sensors that are installed in a deep fryer pot to measure and compare the coloration change of oil from one side of a fryer pot to the other side of a fryer pot.

The present disclosure still yet further provides for an oil quality sensor for a deep fryer, having a first LED coupled to a photosensor and a second LED coupled to a photosensor in which a differential between the signals received by the photosensors is measured as an indication of the absorptivity of the oil.

The present disclosure yet still further provides for an oil quality sensor having a blue LED coupled to a first photosensor and a red LED coupled to a second photosensor, in which when a predetermined differential threshold is detected between the first photosensor signal and second photosensor signal is achieved, an operator is notified to change the oil.

The present disclosure further provides for an oil quality sensor for a deep fryer that is located in the return line of a deep fryer.

The present disclosure further provides for an oil quality sensor and a heater that are disposed in the return line of the recirculation system of a deep fryer.

The present disclosure still further provides for an oil quality sensor that is disposed between the drain valve and the filter pan of the recirculation system of a deep fryer.

The present disclosure still further provides for an oil quality sensor and a heater that are disposed between the drain valve and the filter pan of the recirculation system of a deep fryer.

An sensor for a monitoring oil in a deep fryer system having at least one fryer pot and a pipe directing oil to the fryer pot has a first sensor and a second sensor, and a first transmitter disposed for transmitting light through the oil to the first sensor and a second transmitter disposed for transmitting light through the oil to the second sensor. The sensor also has a processor for comparing a signal received from the first sensor and a signal received from the second sensor, wherein a notification is provided when a difference between signals exceeds a predetermined threshold.

A deep fryer system having an oil quality sensor having a body for receiving oil, a first transmitter disposed proximate the body for transmitting a signal through the oil to a first sensor; a second transmitter disposed proximate body for transmitting a signal through the oil to a second sensor; and a processor for comparing a signal received from the first sensor and a signal received from the second sensor. A notification is provided when a difference between the signals exceeds a predetermined threshold that is indicative of low oil quality.

### BRIEF DESCRIPTION OF THE DRAWING

Other and further benefits, advantages and features of the present disclosure will be understood by reference to the following specification in conjunction with the accompanying drawings, in which like reference characters denote like elements of structure.

FIG. 1 illustrates an exemplary deep fryer housing a sensor and/or sensor and heater of the present invention;

FIG. 2 illustrates an oil quality sensor according to the first embodiment of the present invention;

FIG. 3 illustrates a cross-section view of the sensor of FIG. 1 along line 3-3;

FIG. 4 illustrates a cross-section view of the sensor of FIG. 1 along line 4-4;

FIG. 5 illustrates the first embodiment of the oil quality sensor of FIG. 2 installed in a recirculation system of an exemplary fryer pot, according to the first configuration of the present invention;

FIG. 6 illustrates a second embodiment of the oil quality installed in an exemplary fryer pot, according to the present invention;

FIGS. 7 and 8 illustrate an oil quality sensor, of the second embodiment of FIG. 6, installed in an exemplary fryer pots, according to second and third configurations of the present invention;

FIG. 9 illustrates a second configuration of the oil quality sensor, according to the first sensor embodiment, installed proximate the return valve with an in-line heater, according to the present invention;

FIG. 10 illustrates a third configuration of the oil quality sensor, according to the first sensor embodiment, installed proximate the drain valve of an exemplary fryer pot, according to the present invention; and

FIG. 11 illustrates a fourth configuration of the oil quality sensor according to the first sensor embodiment, installed proximate the drain valve of an exemplary fryer pot with an inline heater, of the present invention.

### DETAILED DESCRIPTION OF THE DRAWINGS

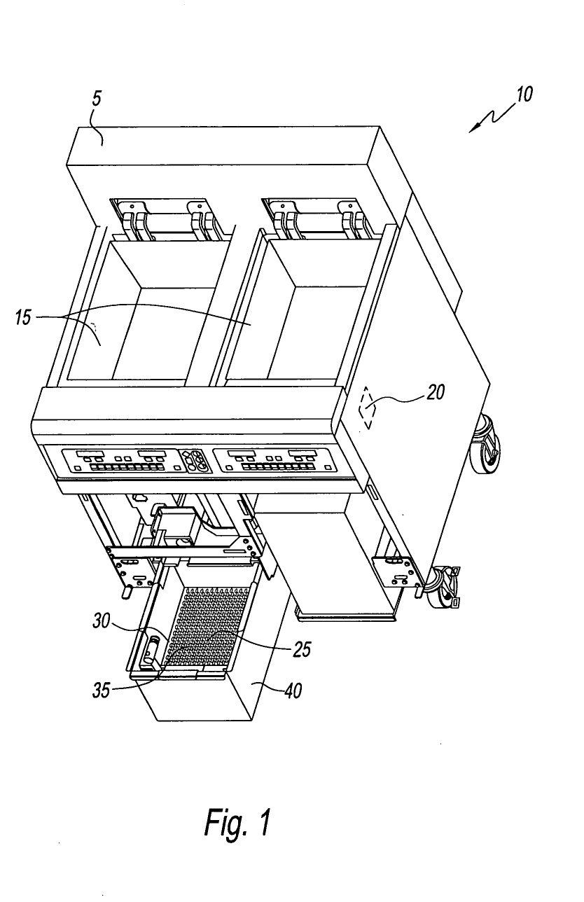

Referring to FIG. 1, an illustration of an exemplary deep fryer is shown, and generally represented by reference numeral 10. Deep fryer 10 has a housing 5, a pair of fryer pots 15 and a pair of filter pans 40. Each of the pair of filter pans 40 contains a filter medium 35, such as for example, a crumb basket 25 and a filter pad 30, for filtering used cooking oil. While deep fryer 1 is shown as only having two fryer pots 15, there could be as many as twelve fryer pots depending upon the needs of the food service professional. Deep fryer 1 also has a controller 20 for monitoring and maintaining overall operation the deep fryer 1.

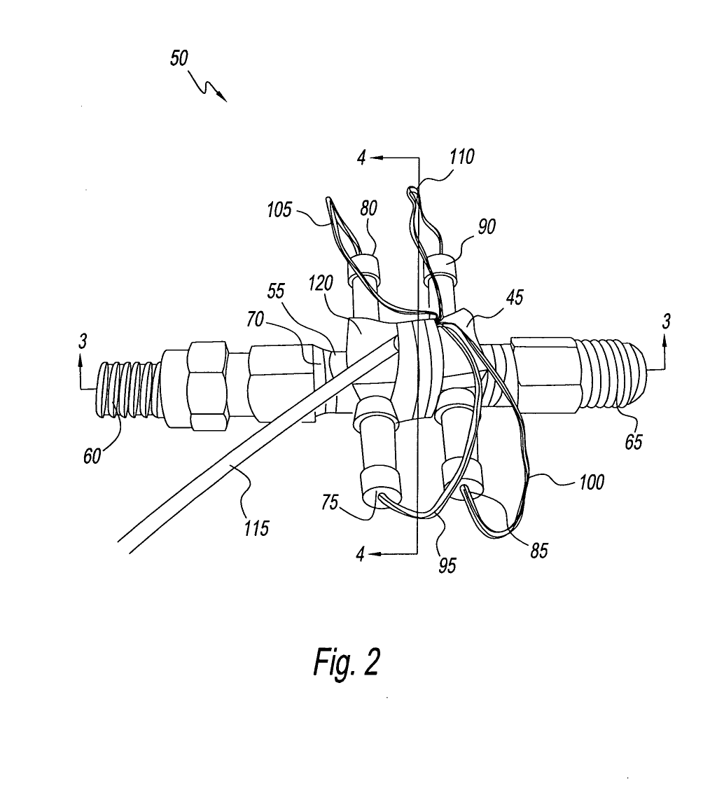

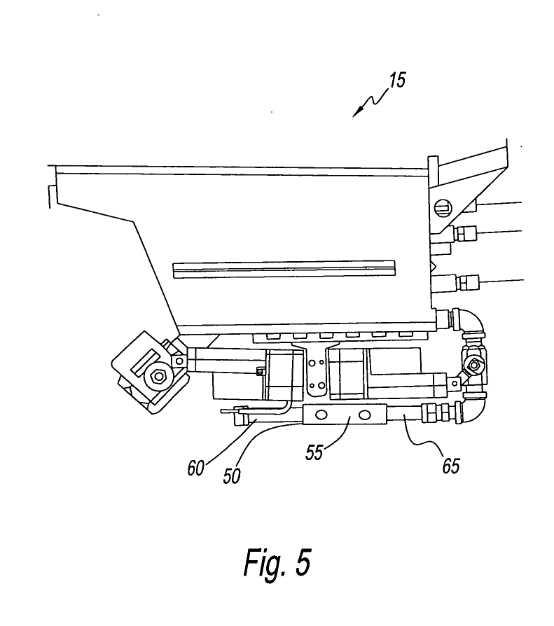

Referring to FIG. 2 an illustration of the oil quality sensor according to the first embodiment of the present invention is shown and generally referenced using reference numeral 50. Sensor 50 has a body 55 that is operatively connected to a pipe 60 at one end and to a second pipe 65 at an opposite end. Pipes 60 and 65 are located in the plumbing system of a fryer pot 15 as shown in FIG. 4, according to the first embodiment of the present invention. Sensor 50 has a sealant 70 between mating parts of body 55 and pipes 60 and 65. Sealant 70 is a commonly known sealant, such as, for example, Teflon tape.

Sensor 50 has a measuring Light Emitting Diode (LED) 75 coupled to a measurement broadband photosensor 80. Sensor 50 has a reference LED 85 coupled to a reference broadband photosensor 90. Each LED 75 and 85 has a wire 95 and 100, respectively associated therewith. Each photosensor 80 and 90 has a wire 105 and 110, respectively, associated therewith. Wires 95, 100, 105, and 110 are bundled in wrap 115 and directed to a processor 20. LEDs 75 and 85 and photosensors 80 and 90 are secured to body 55. An insulator 120 is wrapped around body 55.

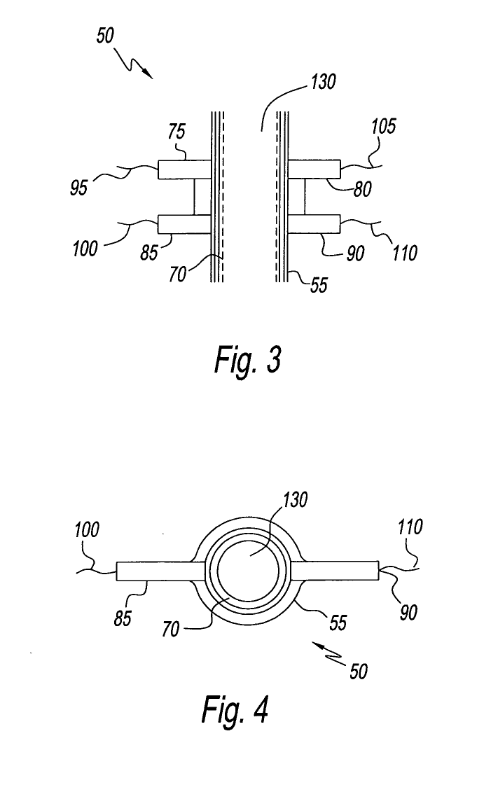

Referring to FIGS. 3 through 4, sensor 50 is further shown in detail. In FIG. 3, a cross-sectional view of sensor 50 is shown. Sensor 50 has a transparent tube 70 inside of body 55. Ends of body 55 and tube 70 are secured together to prevent any oil from leaking therebetween. Light projected from measuring LED 75 is transmitted through oil 130 in tube 70 and is measured by measurement photosensor 80. Similarly, light projected from reference LED 85 is transmitted through oil 130 in tube 75 and is measured by reference photosensor 90. A signal from measuring photosensor 80 is compared to a signal from reference photosensor 90 to determine the change of transmitted light emitted by the LED 75 and LED 85, respectively, detect the degree of oil degradation from the cooking process. The amount of debris present in oil 130 will modify how light from each LED 75 and 85 is transmitted and received by a respective photosensor. The greater the amount of debris present in oil 130, the greater the absorptivity of the oil and thus the greater the modification of the signal received by each photosensor 80 and 90. Depending upon the type of LED used and the photosensor sensitivity, temperature compensation may be required. If a signal returning from a photosensor is not strong, an additional signal would be required to alert a user to clean the surface of tube through which light passes.

In use, sensor 50 functions by using colored LEDs 75 and 85 and photosensors 80 and 90 to determine coloration changes in oil 130 that are indicative of degrading oil quality. A processor periodically transmits and receives signals from LEDs 75 and 85 and photosensors 80 and 90, respectively, to monitor oil quality. Sensor 50 uses a blue light emitted from LED 85 and a red light emitted from LED 25. A blue light's wavelength provides greater degree of variation after passing through oil 130 in comparison to the variation of the wavelength of a red light passing through the same oil. Thus, the red light emitted from LED 85 is used as the reference LED and the blue light emitting LED 75 is used as the measurement LED. Similarly, photosensor 80 is the measurement photosensor and photosensor 90 is the reference photosensor. As oil 130 ages and changes color, its absorptivity changes. With the changes to absorptivity, the colored LEDs 75 and 85 will transmit differently through oil 130 and the light received by respective photosensors 80 and 90, will be modified accordingly. The signals that are received by photosensors 80 and 90 establish parameters for the predetermined threshold. When the difference between the parameters associated with each photosensor 80 and 90 exceeds a predetermined threshold, the operator is instructed to change oil 130. Notification can be achieved by any known mechanism such as for example by a bell or a light.

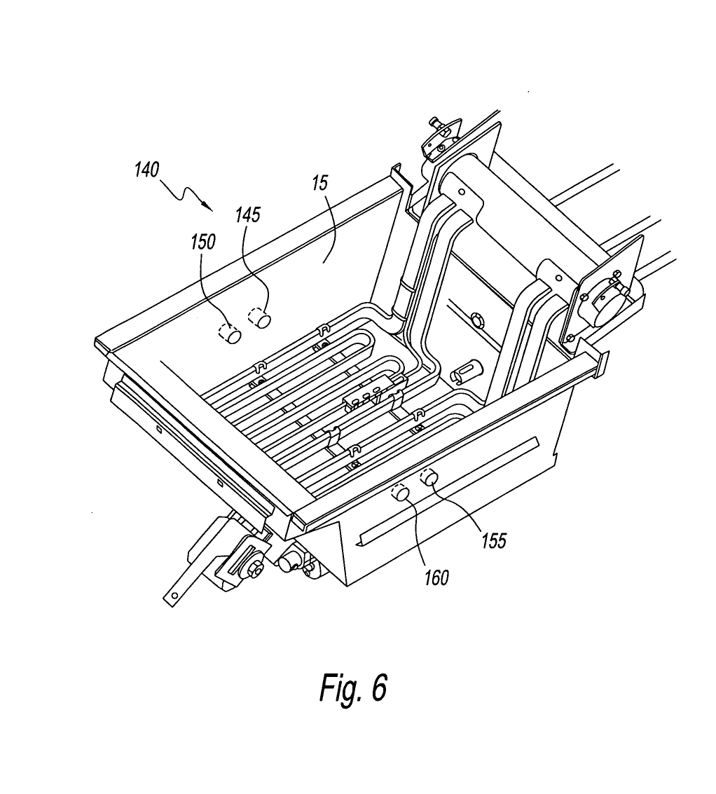

In the first configuration, a first embodiment of oil sensor 50 is located in the recirculation system of fryer pot 15 of fryer 5 as shown in FIG. 5. Sensor 50 is located to sample oil that has been filtered before it re-enters fryer pot 15. By being located in the recirculation system of fryer 5, a single sensor 50 can be used for several fryer pots 15 because they share the recirculation system.

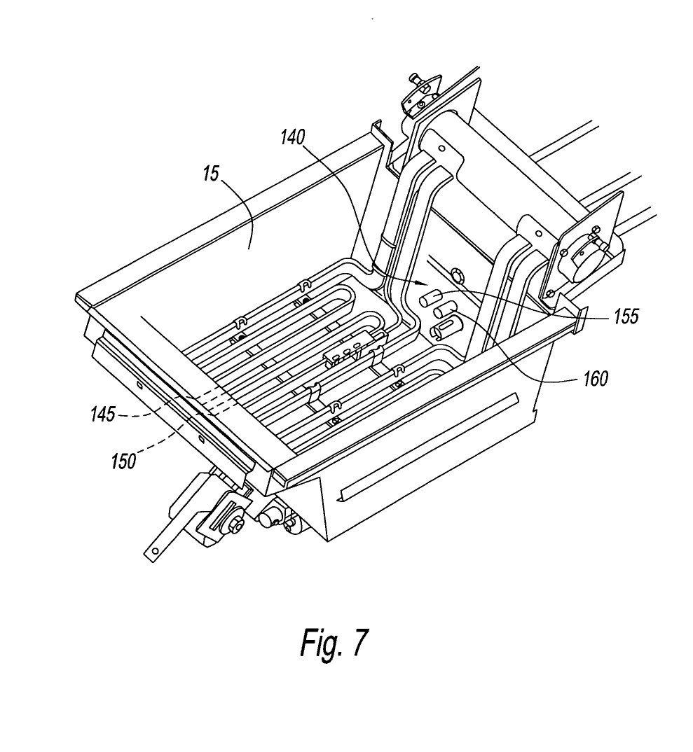

A sensor according to a second embodiment of the present invention, is shown, and referenced using reference numeral 140 in FIG. 6. Sensor 140 is configured to measure the oil quality in a fryer pot 15 across the entire volume of oil 130. Accordingly, sensor 140 is modified in comparison to sensor 50 of the prior embodiment. As opposed to being tubular in construction, sensor 140 has two separate components. One of the two components contains the sensors and the other of the two components contains the LEDs. In this embodiment, oil sensor 140 has a reference LED 145 and a measurement LED 150 on one side of pot 15 and a reference photosensor 155 and a measurement photosensor 160, on the other side of fryer pot. LED 145 is coupled to a reference photosensor 155 and LED 145 is coupled to a measurement photosensor 155.

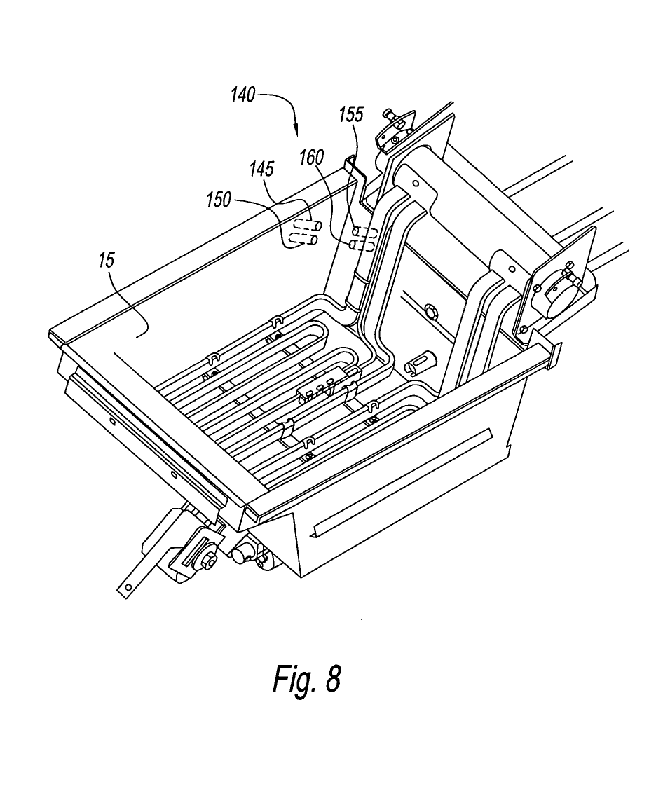

Sensor 140, according to the second embodiment of the sensor of the present invention, has a third configuration as shown in FIG. 7. Sensor 140 is configured to measure the oil quality in a fryer pot 15 across the span of pot 15. Sensor 140 has a reference LED 145 and a measurement LED 150. LED 145 is coupled to a reference photosensor 155 and LED 150 is coupled to a measurement photosensor 160. Wires associated with corresponding LEDs and photosensors are bundled beneath fryer pot 15 and directed to a processor for measuring the difference between the signals sensed by reference photosensor 155 and measurement photosensor 160. After a predetermined threshold is reached between reference photosensor 155 and measurement photosensor 160, an operator is instructed to change the oil in fryer pot 15.

In FIG. 8, a fourth configuration of sensor 140 according to the second embodiment of the present invention is shown. Sensor 140 measures the oil quality across a small portion of fryer pot 15. Sensor 140 has a reference LED 145 and a measurement LED 150. LED 145 is coupled to a reference photosensor 155 and LED 150 is coupled to a measurement photosensor 160. Sensors 155 and 160 are placed at a 45° angle relative to surface of fryer pot 15. Similarly, LEDs 145 and 150 are also placed at a 45° angle relative to the surface of fryer pot to ensure that the transmitted light is received by the appropriate photosensor. When a predetermined threshold difference is measured between signals received from reference photosensor 155 and measurement photosensor 160 is achieved, an operator is instructed to change the oil in fryer pot 15.

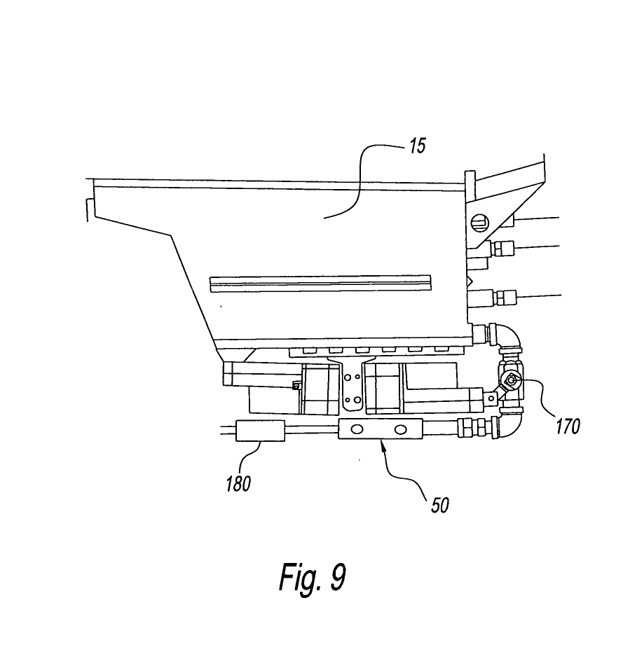

A second configuration of the first embodiment of the sensor 50 is shown in FIG. 9. The second configuration incorporates in fryer pot 15, a sensor 50 that is disposed proximate return valve 170, similar to the first configuration of FIG. 5. However, a heater 180 is disposed inline or in series and before sensor 50 after the cooking oil has been filtered. After the filtration takes place, the temperature of the cooking decreases, thus reducing the oil viscosity. The reduction of oil temperature causes a loss of viscosity any remaining food particles can separate from the oil, thus leading to measurement inaccuracies and potential clogging of the sensor. The benefit of having heater 180 disposed after a filter medium 35, such as that shown in FIG. 1 having crumb basket 25 and filter pad 30, is that the temperature reduction during recirculation filtration can be minimized as well as any potential clogging of the sensor. By minimizing temperature reduction more accurate oil quality measurements can be achieved.

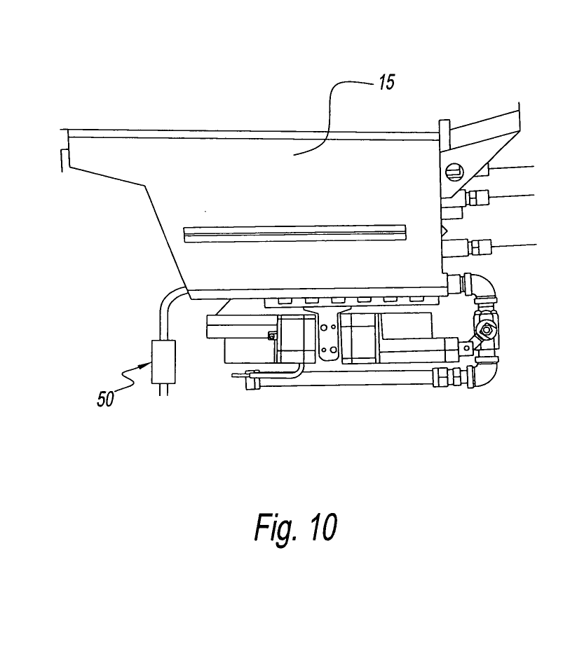

A third configuration using the sensor 50 according to the first embodiment of the of the present invention is shown in FIG. 10. Sensor 50 is disposed between fryer pot 15 and the filter medium 35, such as that shown in FIG. 1. By placing sensor 50 before the filter medium 35, the velocity of circulating oil disturbs any food particles that may have collected in sensor 50. The velocity of the cooking oil allows cleaning of sensor 50 by removing food particles for a more accurate oil quality measurement.

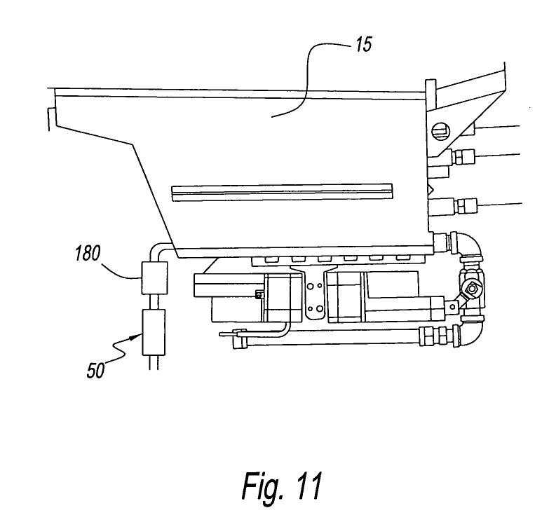

According to the fourth configuration of the present invention, a sensor 50, according to the first embodiment, and a heater 180 are disposed between fryer pot 15 and filter medium 35, as shown in FIG. 11. Again, the heating of the cooking oil by heater 180 minimizes the possibility that any food particles will be separated from the cooking oil thus preventing any potential clogging and inaccurate sensor measurements.

The present invention having been thus described with particular reference to the preferred forms thereof, it will be obvious that various changes and modifications may be made therein without departing from the spirit and scope of the present invention as defined in the appended claims.

We claim:

1. A sensor for a monitoring oil in a deep fryer system having at least one fryer pot and a pipe directing oil to the fryer pot comprising:
a first sensor and a second sensor;
a first transmitter disposed for transmitting light through the oil to said first sensor and a second transmitter disposed for transmitting light through the oil to said second sensor; and
a processor for comparing a signal received from said first sensor and a signal received from said second sensor,
wherein a notification is provided when a difference between said signals exceeds a predetermined threshold.

2. The sensor of claim 1, wherein said notification is indicative of high oil absorptivity.

3. The sensor of claim 1, wherein one of said first sensor and said second sensor is a reference sensor and the other of said first sensor and said second sensor is a measurement sensor.

4. The sensor of claim 1, wherein one of said first transmitter and said second transmitter is a reference transmitter and the other of said first transmitter and second transmitter is a measurement transmitter.

5. The sensor of claim 4, wherein said reference transmitter transmits a light that is received by said reference sensor to establish a parameter of said predetermined threshold.

6. The sensor of claim 4 wherein said measurement transmitter transmits a light that is received by said measurement sensor to establish a parameter of said predetermined threshold.

7. The sensor of claim 1, wherein said signal received from said first sensor and said signal received from said second sensor are signals indicative of oil absorptivity.

8. The sensor of claim 1, wherein the oil being monitored is disposed in a tubular pipe of the deep fryer system.

9. The sensor of claim 8, further comprising a tube received inside of said tubular member.

10. The sensor of claim 9, wherein said tube is a transparent tube member.

11. The sensor of claim 8, wherein said first sensor is diametrically opposed to said first transmitter and said second sensor is diametrically opposed to said second transmitter.

12. The sensor of claim 1, wherein said oil being monitored is in a deep fryer pot.

13. The sensor of claim 12, wherein said first transmitter is disposed on a side of said deep fryer pot opposite said first sensor and said second transmitter is disposed on a side of said deep fryer pot opposite said second sensor.

14. The sensor claim 12, wherein said first transmitter is disposed on a side of said deep fryer pot that is adjacent said first sensor and said second transmitter is disposed on a side of said deep fryer pot that is adjacent said second sensor.

15. The sensor of claim 1, wherein said first transmitter and said second transmitter are a first LED and a second LED.

16. The sensor of claim 1, wherein said first sensor is a first photosensor and said second sensor is a second photosensor.

17. The sensor of claim 1, wherein said notification is one of a visual notification and an audible notification.

18. A deep fryer system having an at least one fryer pot and a filter medium comprising:
a body for receiving oil;
a first transmitter disposed proximate said body for transmitting a signal through the oil to a first sensor;
a second transmitter disposed proximate said body for transmitting a signal through the oil to a second sensor; and
a processor for comparing a signal received from said first sensor and a signal received from said second sensor,
wherein a notification is provided when a difference between said signals exceeds a predetermined threshold, said threshold indicative of low oil quality.

19. The deep fryer system according to claim 18, wherein said first transmitter and said second transmitter periodically send signals to said first sensor and said second sensor.

20. The deep fryer system according to claim 18, wherein one of said first transmitter and said second transmitter is a reference transmitter and the other of said first transmitter and the second transmitter is a measurement transmitter.

21. The deep fryer system of claim 20, wherein one of said first sensor and said second sensor is a reference sensor and the other of said first sensor and said second sensor is a measurement sensor.

22. The deep fryer system according to claim 21, wherein said reference transmitter transmits a light that is received by said reference sensor to establish a parameter for said predetermined threshold.

23. The deep fryer system according to claim 21, wherein said measurement transmitter transmits a light that is received by said measurement sensor to establish a parameter for said predetermined threshold.

24. The deep fryer system according to claim 18, wherein said body comprises a tubular member that is operatively associated with a pipe and the at least one fryer pot of the deep fryer system, said pot having a drain valve and an inlet valve.

25. The deep fryer system according to claim 24, wherein said tubular member is disposed between the filter medium and an inlet valve of the at least one fryer pot of the deep fryer system.

26. The deep fryer system according to claim 24, wherein said tubular member is disposed between the drain valve and the filter medium.

27. The deep fryer system according to claim 24, further comprising a tube received inside of said tubular member.

28. The deep fryer system according to claim 27, wherein said tube is a transparent tube member.

29. The deep fryer system of claim 27, further comprising a heater disposed in-line with the pipe of the deep fryer.

30. The deep fryer system of claim of claim 29, wherein said tubular member is disposed between said heater and the inlet of the at least one fryer pot.

31. The deep fryer system of claim 29, wherein said heater is disposed between a drain valve of the at least one fryer pot and a filter medium and said tubular member is disposed between said heater and said filter medium.

32. The deep fryer system according to claim 23, wherein said first sensor is diametrically opposed to said first transmitter and said second sensor is diametrically opposed to said second transmitter.

33. The deep fryer system according to claim 18, wherein said body comprises a deep fryer pot.

34. The deep fryer system according to claim 29, wherein said first transmitter is disposed on a side of said deep fryer pot opposite said first sensor and said second transmitter is disposed on a side of said deep fryer pot opposite said second sensor.

35. The deep fryer system according to claim 29, wherein said first transmitter and said first sensor are disposed on joining sides of said deep fryer pot and said second transmitter and said second sensor are disposed on adjacent sides of said deep fryer pot.

36. The deep fryer system according to claim 18, wherein said first transmitter and said second transmitter are a first LED and a second LED.

37. The deep fryer system according to claim 18, wherein said first sensor and said second sensor are a first photosensor and a second photosensor.

38. The deep fryer system according to claim 20, wherein said reference transmitter emits a red light and said measurement transmitter emits a blue light.
